(19) United States
(12) Patent Application Publication
(10) Pub. No.: US 2009/0055286 A1
(43) Pub. Date: Feb. 26, 2009

(54) INVERSE MULTIPLE AUCTION

(75) Inventor: Shaul LEVY, Caesaria (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignees: Kaplan, Naim & Co. Ltd. (50%), Tel Aviv (IL); Shaul Levy (50%), Caesaria (IL)

(21) Appl. No.: 12/195,449

(22) Filed: Aug. 21, 2008

Related U.S. Application Data
(60) Provisional application No. 60/957,168, filed on Aug. 22, 2007.

(51) Int. Cl. G06Q 30/00

(52) U.S. Cl. 705/26

(57) ABSTRACT

A method and system for encouraging competition in an on-line auction includes receiving at least one bid to buy an item and communicating the bids or a summary thereof to a plurality of sellers. A seller may respond to the bids by accepting a bid or making an offer. Information on the status of the bidding and offers may be made available to one or more participants to encourage an open market and informed decision making by all participants.

This patent application claims the benefit of U. S. Provisional Patent Application No. 60/957,168, filed Aug. 22, 2007

### FIELD AND BACKGROUND OF THE INVENTION

Various methods and systems for selling and advertising products are possible, and particularly, methods and systems may help sellers and buyers to quickly come to mutually acceptable conditions for a transaction.

In a traditional market, a plurality of buyers and sellers informally barter together to find acceptable terms to make a sale. The traditional market has a few disadvantages. Firstly the communication is ad hoc and thus there may be a buyer and seller pair that could come to acceptable terms and made a sale, but because of limited communication they never come together. Secondly, there is no arbitration and therefore there may be deceit (e.g. bidding without intention to buy, promising payment/delivery and not fulfilling, or including hidden terms that make it impossible for a participant to properly compare offers).

On-line sales offer improved communication and increased reliability over a traditional market. In on-line sales, a large number of sellers advertise products over the media (for example the Internet or television or others) and a large number of buyers seek the product they desire with a suitable price and conditions of sale. Search engines and sales sites that list multiple sellers and products make it easy for a buyer to compare prices and products and choose the best offer. Thus on-line sales make it very convenient for the buyer to choose the most advantageous product to buy. On the other hand, on-line sellers do not have a flexible forum by which to test the market and dynamically adjust their products and prices to make sales. Thus many sellers are stuck with products that do not sell at the advertised price. Other sellers accept unnecessarily low prices because they miss-guessed the demand for their product. This also has a disadvantage for the consumer because often a seller would be willing to sell at a price acceptable to the consumer, but due to miss-guessing demand an offer was never made and the consumer is left empty handed.

There is thus a widely recognized need for, and it would be highly advantageous to have an on-line selling method that helps sellers and buyers to quickly come to mutually acceptable conditions for a transaction.

### SUMMARY OF THE INVENTION

Various methods and systems for an on-line auction are possible. Particularly, a system or method may encourage competition by allowing multiple buyers and sellers to negotiate a price and conditions of sale together. The system and method may further make available a summary of the status of bidding and offers.

An embodiment of a method of auctioning an item may include receiving at least one bid from at least one customer. The customer bids to buy the item. The bid may be communicated to multiple sellers. Some or all of the sellers may respond to the bid by accepting the bid or by making a counter offer (to sell the item under terms differing from the original offer and differing from the bid). Offers from the sellers may be collected and relayed to the customer.

An embodiment of a method of auctioning an item may also include enforcing the bid (for example an auction manager may require that when a seller accepts a bid, the bidder must buy the item).

An embodiment of a method of auctioning an item may also include enforcing the offer (for example an auction manager may require that when a buyer accepts an offer, the seller must sell the item according to the agreed price and conditions).

An embodiment of a method of auctioning an item may also include presenting an updated catalogue of the new bids and offers to another customer (for example when a customer initially enters the auction he may be presented with a catalogue including updated prices reflecting the current state of bidding in the auction).

An embodiment of a method of auctioning an item may also include registering a customer prior to presenting to him a catalogue of offers.

An embodiment of a method of auctioning an item may also include summarizing at least a portion of the bids and offers.

An embodiment of a method of auctioning an item may also include summarizing all of the bids and offers.

In an embodiment of a method of auctioning an item, the summary of the bids and offers may be communicated to one or more of the participants in the auction.

In an embodiment of a method of auctioning an item, the summary of the bids and offers may be communicated to all participants in the auction.

An embodiment of a method of auctioning an item may also include facilitating a two-way communication link between a customer and the seller. The customer and seller may use the link for direct communication of offers and bids.

An embodiment of a method of auctioning an item may also include registering a customer before receiving a bid from the customer.

An embodiment of a method of auctioning an item may also include one or more of charging a customer for registering to participate in the auction, charging a seller according to the number of times his offer is relayed to a customer, charging a seller a fee for advertising his offer in an on-line catalogue, charging a seller a fee for a facilitating two way communication between a customer and the seller, charging a sellers for communicating to the seller a summary of the bids and offers, charging a seller a commission upon completion of a sale, charging a participant (seller or customer) for supplying information (for example for communicating to him a summary of bidding and offers or for supplying seller information).

In an embodiment of a method of auctioning an item, a bid may include a price and a condition of sale under which the customer agrees to buy the item at the bid price.

In an embodiment of a method of auctioning an item, a single seller may offer more than one offer for a single item (the multiple offers may differ in price or in conditions of sale).

In an embodiment of a method of auctioning an item, an offer may include a condition under which the offer is to be presented to a customer. The offer will not be relayed or presented to customer who does not fulfill the condition.

An embodiment of a system for auctioning an item may include a communication medium configured for communicating a bid from a customer to multiple sellers. The system may also include a memory configured for storing an offer from a seller to the customer. The offer may be a response to the bid.

An embodiment of a system for auctioning an item may further include a processor configured to enforce the bid. Particularly, for example, enforcing the bid include storing credit information of the customer, making a sale final and charging the customer's credit account upon acceptance of the bid.

An embodiment of a system for auctioning an item may further include a processor configured to enforce an offer. For example, a seller that refuses to honor an offer for sale that was accepted by a customer may be removed from the auction.

In an embodiment of a system for auctioning an item, the communication medium may further be configured to present an updated catalogue to another (e.g. a new) customer. The updated calendar may include offers made during the auction.

In an embodiment of a system for auctioning an item, the communication medium may be further configured to communicate a summary of some of the bids and offers to a participant in the auction (for example the participant may be a customer or a seller).

In an embodiment of a system for auctioning an item, the communication medium may be further configured to communicate a summary of all of the current bids and offers to some or all participants in the auction.

In an embodiment of a system for auctioning an item, the communication medium may be further configured to facilitate two-way communication between a customer and a seller.

An embodiment of a system for auctioning an item may further include a processor configured to compute one or more of a fee to a customer for registering to participate in the auction, a fee to a seller according to the number of times the seller's offer is relayed to a customer, a fee to a seller for advertising his offer in an on-line catalogue, a fee to a seller a for a facilitating two way communication between a customer and the seller, a fee to a sellers for communicating to the seller a summary of the bids and offers, a commission to charge a seller upon completion of a sale, a fee to a participant (seller or customer) for supplying information (for example for communicating to him a summary of bidding and offers or for supplying seller information).

### Terminology

The following terms are used in this application in accordance with their plain meanings, which are understood to be known to those of skill in the pertinent art(s). However, for the sake of further clarification in view of the subject matter of this application, the following explanations, elaborations and exemplifications are given as to how these terms may be used or applied herein. It is to be understood that the below explanations, elaborations and exemplifications are to be taken as exemplary or representative and are not to be taken as exclusive or limiting. Rather, the terms discussed below are to be construed as broadly as possible, consistent with their ordinary meanings and the below discussion.
Bidding means making a unilateral offer to buy a product under certain conditions for example at a set price and for a limited time.
Offering means making a unilateral offer to sell a product under certain conditions for example at a set price and for a limited time.
Accepting means agreeing to fulfill the bid or offer of another sale participant; thus a seller accepts a bid of a buyer by promising to supply the product at the bid price and conditions; a buyer accepts an offer of a seller by agreeing to pay the offered price to acquire the product.
A customer is a person who shows an interest in buying an item. Showing interest may include looking at a catalogue of items for sale or making a bid.

### BRIEF DESCRIPTION OF THE DRAWINGS

Various embodiments of a method and system for investment are herein described, by way of example only, with reference to the accompanying drawings, where.

FIG. 1 is a generalized flowchart of an example of an auction;

FIG. 2 is a high level block diagram of an auction;

FIG. 3a is a buyer initial screenshot at the beginning of the example of FIG. 2;

FIG. 3b is a summary screenshot during the example of FIG. 2;

FIG. 3c is a revised summary screenshot during the example of FIG. 2;

FIG. 3d is a revised buyer screenshot at the end of the example of FIG. 2.

### DESCRIPTION OF THE PREFERRED EMBODIMENTS

The principles and operation of a method and system for helping sellers and buyers to quickly come to mutually acceptable conditions for a transaction may be better understood with reference to the drawings and the accompanying description.

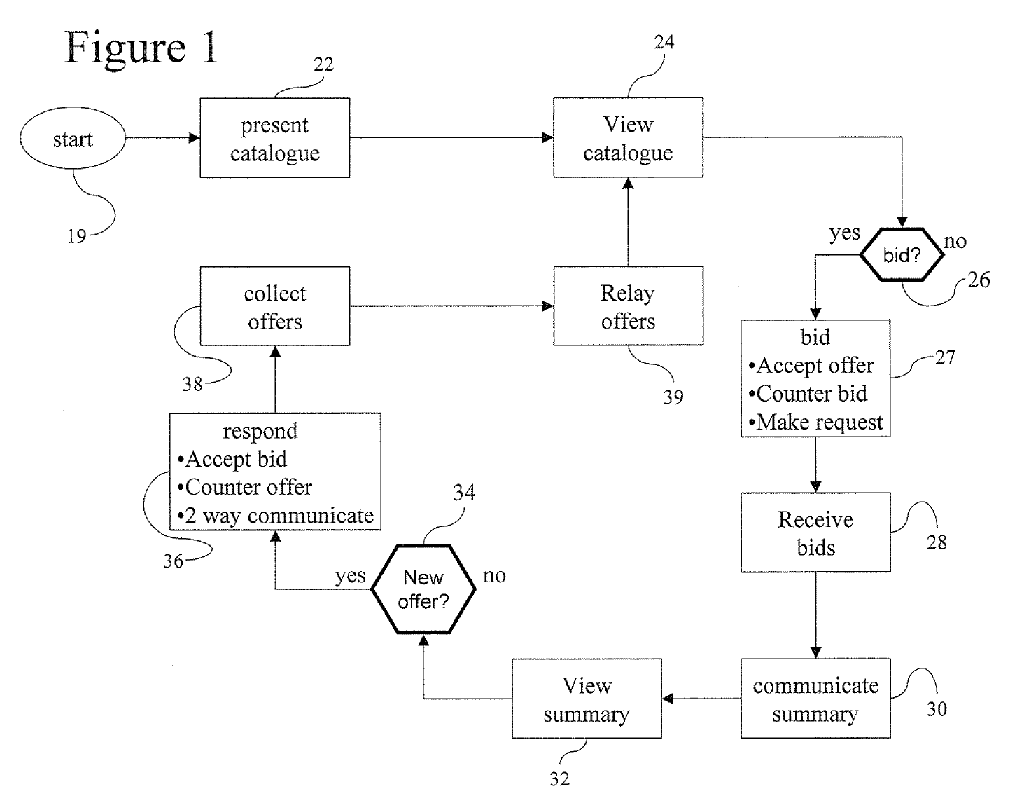

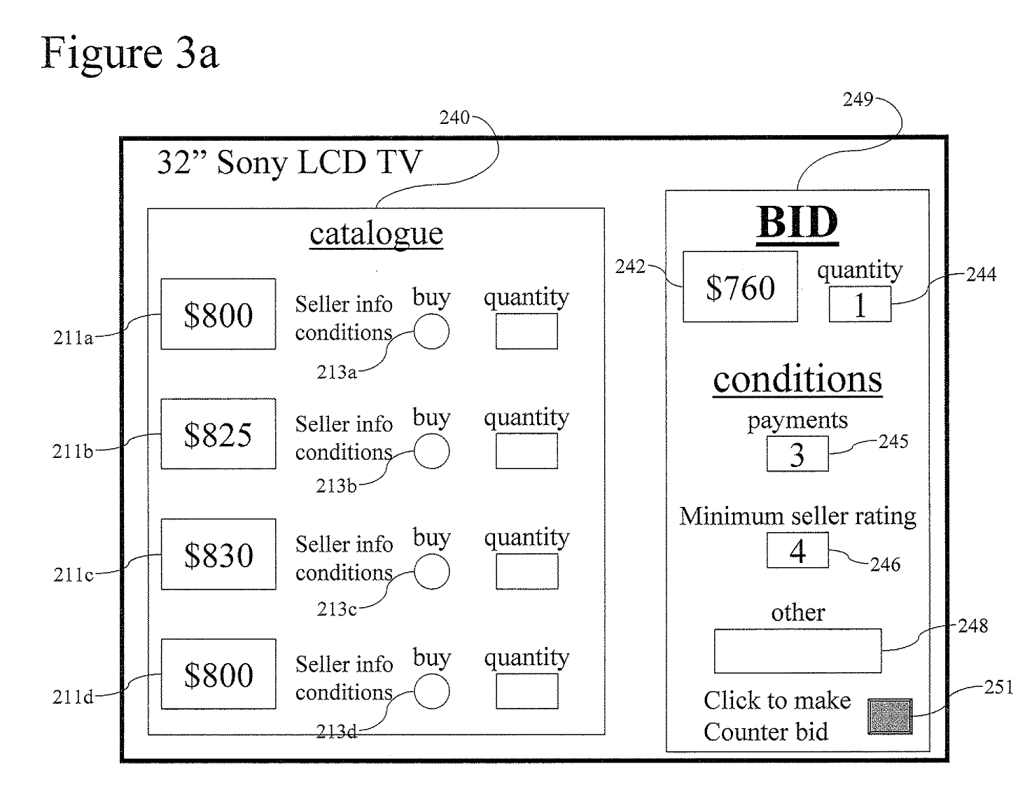

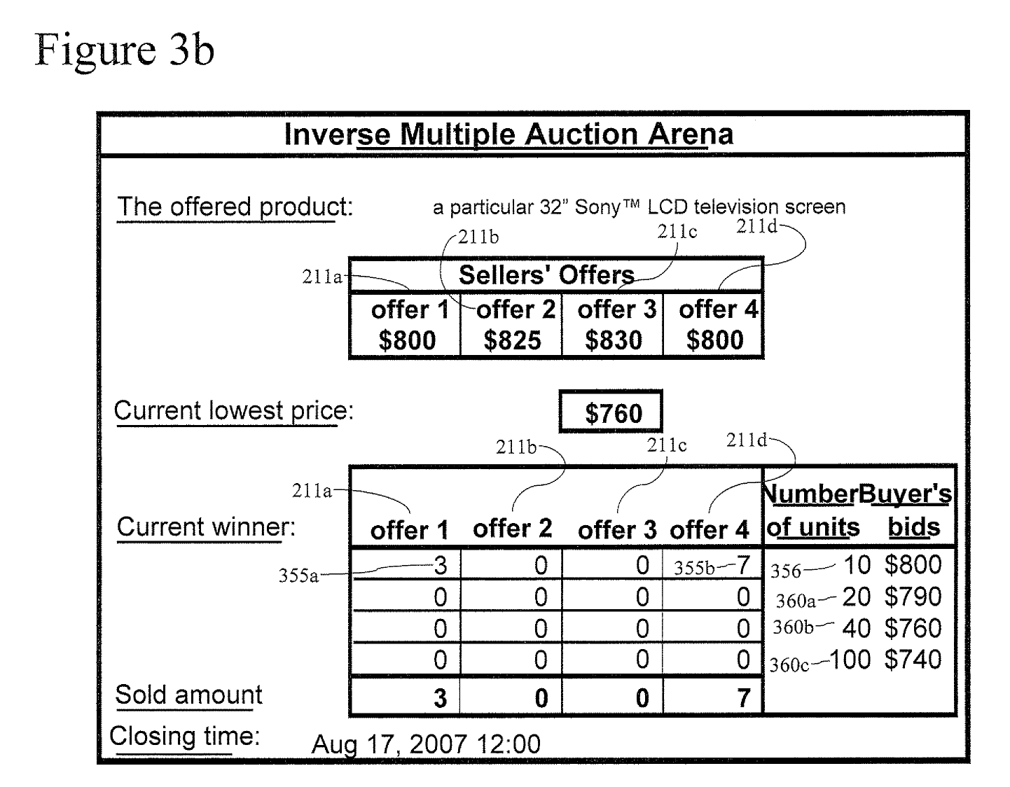

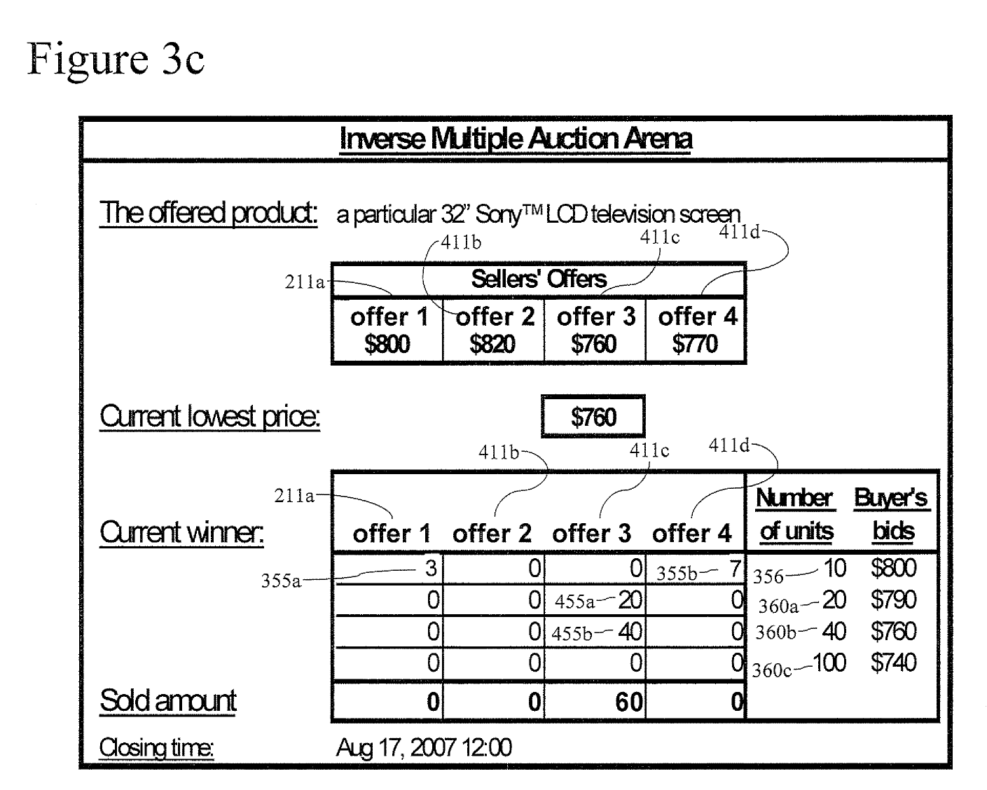

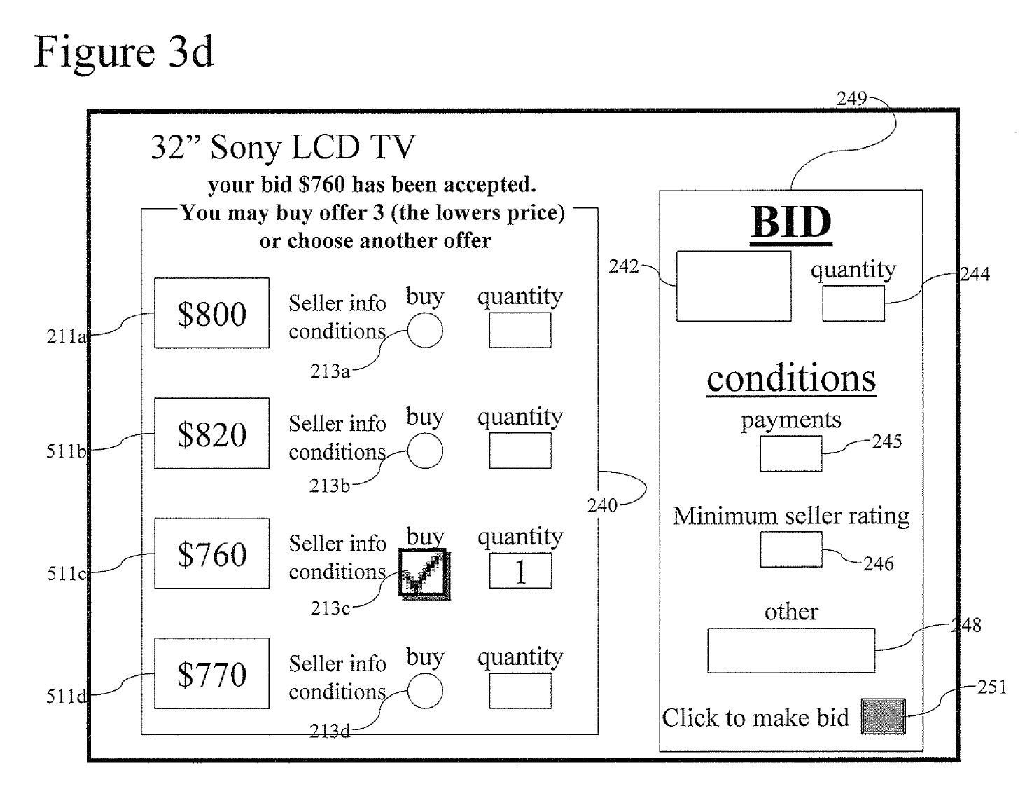

Referring now to the drawings, FIG. 1 is a flow chart illustrating a method of selling an item. The process starts (box 19) when a customer logs on to an auction site on the Internet and asks to see offers for an item. An auction manager relays (box 22) to the customer a initial catalogue of initial offers (e.g. see FIG. 3 accompanying description). The customer views (box 24) the initial catalogue and decides (box 26) whether to make a bid. If the customer does not bid, the process waits until further updates or requests. If the customer decides (box 26) to bid (box 27), he may accept one of the offers in the initial catalogue (thus buying the item according to one of the initial offers) or he may make a counter bid or he may make a request (the difference between a request and a counter bid is that a counter bid is a commitment to buy if the bid is accepted whereas a request is without commitment).

As will be explained hereinbelow, the initial offers catalogue may be static (each seller specifies an initial offer and even if the seller accepts from a particular customer a lower offer, the initial offers catalogue remains with the initial offer price). Alternatively, the initial offers catalogue may be updated according to the state of on-line bidding or according to instructions of the sellers.

The auction manager receives (box 28) the bid and communicates (box 30) to a participant a summary of the state of the auction (bidding and offers e.g. see FIG. 4 and the accompanying description). As will be explained hereinbelow, the summary may be available to all of the participants in an auction (sellers and customers) or alternatively the summary may be available only to particular participants (for example only to sellers or only to preferred customers or members of an auction club). Furthermore, in one embodiment in order to encourage competition the summary may include all the bids and offers or alternatively the summary may include only a portion of the bids and offers (for example a seller may be allowed to specify that a certain offer is to be made privately only to a particular customer or a customer may specify that a certain bid is to be made privately only to certain customer or that the details of a sale is not to be communicated to other customers or alternatively a seller may specify that an initial customer [who has not yet bid on an item] be allowed to see only a portion of offers specified as initial offers).

A seller views (box 32) the summary and decides (box 34) whether to respond (box 36) to the bid. Responding (box 36) may include accepting the bid (and selling the item at the price chosen by the bidder) or making a counter offer or opening a line of direct communication between the seller and the bidder in order to come to terms acceptable to both.

Alternatively, responding (box 36) may be automated. For example, the seller may supply a set of prices and conditions (when to offer a given price to a customer) to the auction manager. The auction manager can program a processor to offer the prices according to the conditions automatically.

The auction manager collects (box 38) the offers and relays (box 39) the new offers to the customer in an updated catalogue. The customer views (box 24) the updated catalogue and continues the process until mutually acceptable terms of sale are found or the customer gives up and logs out.

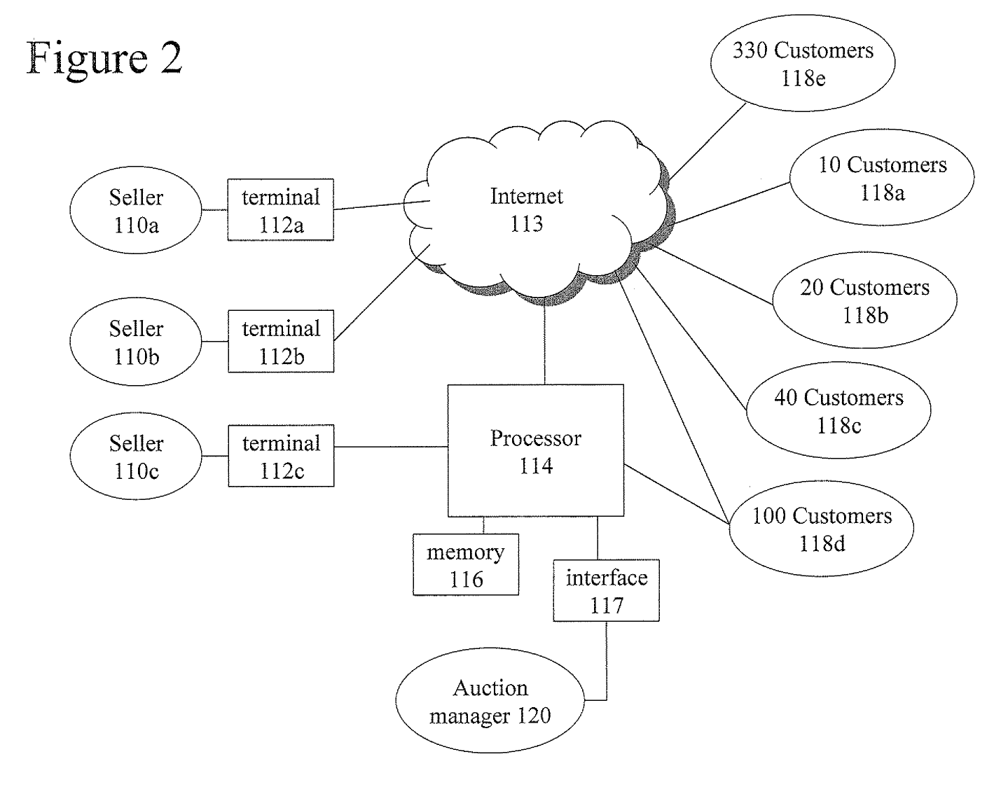

FIG. 2 is illustrates a system to manage and stage a flexible on-line multiple auction. Customers 118a-d bid to buy an item (in general there needs to be at least one customer), in the example of FIG. 2 there are 500 customers 118a-e. Sellers 110a-c bid for the chance to sell one or more items. The flexible format of the auction allows buyers and sellers to negotiate and adjust the price and conditions of sale to maximize benefit and commerce based on supply and demand, leading to a more efficient competition.

In the first example (illustrated in FIG. 2), sellers 110a-c are competing to sell a single item (a particular model 32″ Sony™ LCD television screen). Alternatively sellers may compete to sell similar items (all of the sellers may be offering a 32″ LCD television screen, but the screen offered by the first seller may be of a different manufacturer or have different features from the screen offered by the second seller). The sellers may adjust the offered price and conditions of sale according to supply and demand.

A single seller may also make more than one offer. For example a seller my place one price static in an initial on-line catalogue that can be seen by any customer, but the seller may stipulate that if a buyer makes an offer, then the seller will accept bids of less than the initial catalogue price. Alternatively, in order that the market be open, all prices may be constantly updated and thus the initial price in the on-line catalogue will be the minimum price offered in the on-line auction. Alternatively, the initial catalogue price may be updated only on request of a seller (for example if the seller sees that customers are buying a competitor's item at a lower initial price).

In the example of FIG. 2 seller 110a has 100 units to sell. Seller 110a stipulates that when a customer requests to view box 24) an initial catalogue 240 (see FIG. 3: initial catalogue 240 is presented to a customer who has not made an offer) a first initial offer 211a price will be $800 with a stipulation of immediate payment and a second initial offer 211c price will be $830 with a condition of up to 4 monthly payments. Seller 110b sets an initial offer 211b price of $825 and seller 110c sets an initial offer 211d price of $800.

Each seller 110a-c has a corresponding terminal 112a-c with which to communicate with an auction manager 120. For example terminal 112a is a desktop computer and communication between auction manager 120 and seller 110a is via an auction web site over the Internet 113. Terminal 112b is a handheld computer and communication between auction manager 120 and seller 110b is via e-mail over the Internet 113. Terminal 112c is a cellular phone and communication between auction manager 120 and seller 110c is via direct SMS messaging.

Auction manager 120 directs buying and selling using a desktop computer consisting of a processor 114 a memory 116 and a user interface 117 (having a keyboard, mouse and view screen). Note alternatively, at convenience of the auction manager 120, for example when auction manager 120 is traveling, interface 117 could be a laptop computer or a mobile device such as a cellular phone or a handheld computer.

500 customers 118a-e are currently participating in the auction of the example of FIG. 2. Some of customers 118a-e are communication with auction manager 120 via Internet 113 while some of customers 118d communicate directly with auction manager 120 (for example via SMS messenger or fax or telephone or the like).

FIG. 3a is a screen snapshot of the initial catalogue presented to a customer searching for a 32″ LCD television. The initial screen includes an initial catalogue 240 displaying initial offers 211a-d. A buyer may choose to accept one of initial offers 211a-d and buy an item according to an initial offer 211a-d by specifying a quantity and clicking a corresponding buy button (213a-d). Otherwise the customer can make a counter bid in a bid box 249 by specifying a bid price 242, a bid quantity 244, a number of payments 245, a minimum seller rating 246, and any other conditions 248 for the sale and clicking a make a counter bid button 251. It should be noted that the 4 offers 211a-d displayed to the customer are actually initial offers of 3 sellers 110a-c. Seller 110a made two offers 211a and 211c and seller 110b made initial offer 211d and seller 110c made offer 211d.

In the example of FIG. 3a the customer has chosen to bid $760 for the TV (as is shown in bid price 242.

FIG. 3b is an illustration of a screen snapshot from a summary communicated to a seller in the example of FIGS. 1, 2, 3a-d. Particularly in the example there are 500 customers. 10 customers 356 (FIG. 2 118a) have accepted the initial offer of $800 for a 32″ Sony™ LCD TV (3 of customers 118a elected to accept 355a offer 211a from seller 110a and 7 of customers 118a accepted 355b offer 211d from seller 110c. Once a customer has accepted an offer, he can not go back and therefore even in the sellers reduce their prices later, customers 118a have already accepted to pay $800 for their televisions.

20 customers 118b have bid 360a $790 for such a TV, 40 customers 118c have bid 360b $760 for such a TV, 100 customers 118d have bid 360c $740 for such a TV, and 330 customers 118e have shown an interest in such a TV by requesting to see the page of sale of such an item, but have yet to bid on the item.

Thus seller 110a who has 100 TV screens to sell sees that according to the current bidding if he offers the screens at $760 per screen he will sell only 60 screens and if he offers the screens at a cash price of $740 per screen he will sell all of his screens. Similarly by accepting payment of $760 over five months he will sell 60 screens whereas if he insists on cash payment he will sell only 50. A seller can also see what his competitor has offered. Similarly each buyer is allowed to buy a product according to a current offer of any of seller, or the buyer can make a counter bid on a product.

The auction can be adjusted to have a more open forum (in order to encourage competition) by making all information (e.g. the number of items available, and information on all bids and all offers) equally available to all participants (customer/bidders/buyers and sellers). In such an embodiment, the summary screen of FIG. 3b would also be communicated to all customers and sellers. Thus when a customer entered the auction web site he would see a catalogue page with enticing offers and pictures and convenient menus for searching for a particular products and prices. The catalogue would constantly be updated with the latest offer made by each seller. When the customer finds a product of interest he has an option to see the summary page for auctions of the particular product and similar products. Thus each participant has access to all information on all of the bids and offers.

Alternatively, access to information could be equal to all participants, but there could be provision for private offers where a single seller offers a product to a particular customer at a particular price that is not reported to other participants. Thus, a seller would be able to sell an item to a particular customer without undercutting the entire market. Thus the summary presented to a customer would include only a portion of the offers.

Alternatively, there could be information that is reported only to sellers and other information that is reported only to buyers. Similarly there could be preferred clients who are allowed access to more information than others (becoming a preferred client could depend on a buying/selling record or it could depend on paying of a membership fee). Alternatively, the auction master could offer extra information at any time for a fee to some or any of the participants.

FIG. 3c an illustration of a screen snapshot from a revised summary communicated to a seller in the example of FIGS. 1, 2, 3a-d after sellers 110a-c have responded to the bids. Particularly, seller 110a reduced the price of offer 211c to revised offer 411c $760 in the expectation that customers 118b,c will buy his product. Seller 110c has reduced the price of his offer 211c to revised offer 411d to $770, but will probably get no new customers since revised offer 411c of seller 110a undercut his offer. Seller 110b reduced offer 211c to offer 411b $820 but will probably not sell anything since he is also being undercut.

On the presumption that they will accept the lowest offer, bids 360a and 360b (customers 118b,c) have been assigned 455a,b to offer 411c. Each customer may agree to the sale as is illustrated below or choose to purchase from one of the other sellers (as explained below in FIG. 3d and the accompanying text).

FIG. 3d is a screen snapshot of the updated screen of relayed to the customer of FIG. 3a after sellers 110a-c have revised their offers. The buyer is informed that his offer of $760 dollars has been accepted and the corresponding buy button 213c has been checked. Because the customer's offer has been accepted he is required to buy the product, but if he does not like the conditions of revised offer 511c, he may choose one of the other offers 211a, 511b or 511d by clicking (to toggle off) buy button 213c and then clicking one of buy buttons 213a, 213b or 213d.

Alternatively, there will also be displayed the number of units offered by each seller. Thus, a buyer can also see that currently there remain 250 unsold television screens and there are already 70 offers of $760 per screen. Thus, the buyer can adjust his offer according to the supply and demand. Details of the products and conditions of sale and bidding are changed dynamically and are supplied on-line to each participant. Alternatively, some details of the market may be hidden from some participants. Products offered for sale include physical items, services, digital products (songs, movies . . . ) and information.

In one alternative embodiment, the auction manager arbitrates the auction. Particularly the auction manager may enforces both offers and bids so that they may not be rescinded (thus if a seller offers a product at $100 and a buyer accepts, then both the seller and the buyer are obligated to fulfill the sale, similarly if a buyer offers $100 and a seller accepts, both the buyer and seller are obligated to fulfill the sale). The manager of the auction is responsible to verify financial arrangements (for instance the manager may require that each buyer or seller supply credit card information or a bank security deposit or membership in a auction club) in advance such that participants have a reasonable expectation that products will be supplied and prices will be paid. Alternatively the auction manager may arbitrate by enforcing only bids or only offers.

The entire system may be displayed in a web site that allows the general public to make offers and also see the current status of sale and bids. Alternatively, bids can be managed via e-mail or telephone or an alternative means and information on the status of the auction may be communicated on a web site or via SMS or other communication means known to those skilled in the art of on-line sales. Participation may be limited to registered participants or may be open to the general public. Alternatively, limited information and participation may be available to the general public and more complete information and participation may be available to particular registered users.

The auction manager may further make available a chat line (voice, text, multimedia or otherwise) allowing direct communication between a particular buyer and a particular seller. Thus, a particular buyer and a particular seller can customize conditions of sale. For example a particular buyer may offer to buy multiple products at a reduced price, or a seller may offer to reduce the price if the buyer will supply further customers or the conditions of delivery and payment may be negotiated.

Being that some sellers may be considered preferable (for example due to their reputation as trustworthy in regards to speedy delivery or service or due to preferable product) buyers may specify a different price to different sellers.

The manager of the auction may collect a fixed fee from each buyer or seller. Alternatively the auction manager may charge a fee that depends on the volume and price of sales, the number of offers made, the number of customers to whom offers were relayed or presented etc.

In sum, although various example embodiments have been described in considerable detail, variations and modifications thereof and other embodiments are possible. Therefore, the spirit and scope of the appended claims is not limited to the description of the embodiments contained herein.

What is claimed is:

1. A method of auctioning an item comprising:
a) receiving at least one bid to buy the item from at least one customer;
b) communicating said at least one bid to a plurality of sellers;
c) collecting at least one offer from at least one of said plurality of sellers, wherein said at least one offer is in response to said at least one bid, and
d) relaying said at least one offer to said at least one customer.

2. The method of claim 1, further comprising:
e) enforcing said at least one bid.

3. The method of claim 1, further comprising:
e) enforcing said at least one offer.

4. The method of claim 1, further comprising:
e) presenting an updated catalogue including said at least one offer to another customer.

5. The method of claim 4, further comprising:
f) registering said another customer prior to said step of presenting.

6. The method of claim 1, further comprising:
e) summarizing at least a portion of said at least one bid and said at least one offer.

7. The method of claim 6, wherein said at least a portion is all of said at least one bid and said at least one offer.

8. The method of claim 6, wherein a result of said summarizing is communicated to at least one participant in said auction.

9. The method of claim 6, wherein a result of said summarizing is communicated to all participants in said auction.

10. The method of claim 1, further comprising:
e) facilitating two-way communication between said at least one customer and said at least one seller.

11. The method of claim 1, further comprising:
e) registering said at least one customer prior to said step of receiving.

12. The method of claim 1, further comprising:
e) charging a fee selecting from charging a customer for registering, charging a seller for said relaying, charging a seller for including an offer in a catalogue, charging a seller from said plurality of sellers for facilitating two way communication between said at least one customer and said seller, charging at least one of said plurality of sellers for said communicating, charging a seller of said plurality of sellers upon completion of a sale, charging a participant for supplying information.

13. The method of claim 1, wherein said at least one bid includes a price and a condition of sale.

14. The method of claim 1, wherein at least one offer includes a plurality of offers from exactly one of said plurality of sellers.

15. The method of claim 1, where an offer of said plurality of offers includes a condition for presenting said offer to a customer.

16. A system for auctioning an item comprising:
a) a communication medium configured for communicating at least one bid from at least one customer to a plurality of sellers, and
b) a memory for storing at least one offer from at least one of said plurality of sellers, wherein said at least one offer is in response to said at least one bid.

17. The system of claim 16 further comprising:
c) a processor configured to enforce said at least one bid.

18. The system of claim 17, wherein said memory is further configured to store payment information of a customer.

19. The system of claim 16 further comprising:
c) a processor configured to enforce said at least one offer.

20. The system of claim 16, wherein said communication medium is further configured to present an updated catalogue including said at least one offer to another customer.

21. The system of claim 16, wherein said communication medium is further configured to communicate a summary of at least a portion of said at least one bids and said at least one offers to a participant in said auction.

22. The system of claim 21, wherein said at least a portion includes all of said at least one bids and all of said at least one offers.

23. The system of claim 21, wherein said communication medium is further configured to communicate said summary to all participants in said auction.

24. The system of claim 16, wherein said communication medium is further configured to facilitate a two way communication link between said at least one customer and said at least one seller.

25. The system of claim 16, further comprising
c) a processor configured to compute a fee selecting from the group consisting of a charge to a customer for registering, a charge to a seller for said storing, a charge to a seller for including an offer in a catalogue, a charge to a seller for facilitating two way communication between said at least one customer and said seller, a charge to a seller of said plurality of sellers for said communicating, a charge to a seller of said plurality of sellers upon completion of a sale, and a charge for disclosing information about a seller to a customer.
